(19) United States
(12) Patent Application Publication
(10) Pub. No.: US 2004/0166813 A1
(43) Pub. Date: Aug. 26, 2004

(54) Cartesian loop systems with digital processing

(76) Inventors: Stephen Ian Mann, Christchurch (NL); Mark Anthony Beach, Bristol (GB)

Correspondence Address: Donald J Featherstone, Sterne Kessler Goldstein & Fox, Suite 600, 1100 New York Avenue NW, Washington, DC, 20005-3934, US

(21) Appl. No.: 10/468,740

(22) PCT Filed: Feb. 25, 2002
(86) PCT No.: PCT/NZ02/00023

(30) Foreign Application Priority Data
Feb. 23, 2001 (GB) 0104535.0

(51) Int. Cl. H04B 1/38

(52) U.S. Cl. 455/69; 455/73

(57) ABSTRACT

A Cartesian loop system for radio transmitters in which at least part of the baseband processing is carried out in the digital domain. Digital processing circuitry (250) combines a baseband input signal with a Cartesian feedback signal (206,207) to generate a forward signal. Analog circuitry (221, 201, 203, 204) converts the forward signal into a transmission output signal and generates the Cartesian feedback signal. Preferably the digital processing circuitry applies a phase shift process (208) to the Cartesian feedback signal before combination with the baseband input signal. The system is programmable allowing a single device to be used in a range of transmitters under different radio standards.

### FIELD OF TEE INVENTION

This invention relates to Cartesian loop systems with digital processing of baseband signals and in particular but not only to systems that are used in linearisation of radio transmitter equipment.

### BACKGROUND TO THE INVENTION

Standards relating to radio communications such as TETRA, UMTS and EDGE generally require a high degree of linearity in transmitter equipment to reduce noise between closely spaced radio channels. Linearisation of power amplifiers in transmitter equipment has been extensively researched and many techniques such as Cartesian loop, Polar loop, Envelope Elimination and Restoration, LINC and CALLUM have been produced.

Linearity and bandwidth are traded off in these techniques, giving high linearity being possible over narrow bandwidth, with moderate linearity over a broader bandwidth. Most techniques also trade linearity for efficiency. Power amplifiers used in radio transmitters are more efficient when operated at higher power but then have lower linearity, particularly near their peak power ratings. These techniques are less satisfactory for mobile communications which require both high linearity and also high efficiency for longer battery life and lower weight

The Cartesian loop technique involves negative feedback applied to a baseband input signal having inphase and quadrature components. The feedback signal is a measure of distortion introduced in the forward path of the loop, primarily by the amplifier, and is subtracted from the input signal in real time. This modifies the input signal with an error signal that tends to cancel the distortion at the output of the amplifier and accounts for changes in distortion over time. A phase shift is applied to counter RF delays around the loop.

Cartesian loop systems are generally implemented in analog form which creates several practical disadvantages and reduces their suitability for radio equipment. The analog phase shifter is physically bulky and may introduce additional noise and distortion. Different channels usually require different phase shifts and different optimum settings. The circuit requires several extra ADC and DAC components for calibration of the phase shifter and DC offsets. Overall, analog Cartesian systems can be cumbersome to program and configure, and to implement in hardware.

Predistortion is a digital alternative to Cartesian loop that is sometimes used, although it too has disadvantages. Predistortion involves a digital distortion characteristic that is complimentary to that of the amplifier and to other non-linear devices in the circuit. The characteristic is determined by a training sequence and then by ongoing adaptation to counter changes in non-linearity over time. A lookup table contains predistortion parameters that may be applied to the input signal in various ways.

### SUMMARY OF THE INVENTION

It is an object of the invention to provide improved Cartesian loop Systems for radio transmitters, or at least to provide alternatives to existing systems. In general terms, the baseband signals in these systems are at least partly processed by digital means.

In one aspect the invention maybe said to consist in a Cartesian loop system for radio transmission equipment comprising: digital processing circuitry that combines a baseband input signal with a Cartesian feedback signal to generate a forward signal, coupled to analog circuitry that converts the forward signal into a transmission output signal and generates the Cartesian feedback signal. Preferably the digital processing circuitry applies a phase shift process to the Cartesian feedback signal before combination with the baseband input signal.

In another aspect the invention consists in a method of linearising a radio transmitter comprising: (a) receiving a baseband input signal for transmission, (b) digitally combining the input signal with a Cartesian feedback signal to generate a modified signal, (c) upconverting and amplifying the modified signal to generate a radio frequency output signal, and (d) generating the Cartesian feedback signal from the radio frequency output signal. Preferably the the Cartesian feedback signal is digitally phase shifted before combination with the baseband input signal

### LIST OF FIGURES

Preferred embodiments of the invention will be described with respect to the accompanying drawings, of which:

FIG. 1A shows an analog Cartesian loop system,

FIG. 1B shows a radio transmitter including the analog Cartesian system,

FIG. 2 shows a Cartesian loop system with digital processing of the baseband signal,

FIG. 3 shows a Cartesian loop system with digital processing of the baseband and modulation stages, using an intermediate frequency

FIG. 4 shows a possible Weaver modulation path for FIGS. 2 and 3,

FIG. 5 shows a Cartesian loop system with digital processing of the baseband and modulation stages, without an intermediate frequency,

FIGS. 6A, 6B show alternative digital processing stages for FIGS. 2, 3 and 5,

FIG. 7 shows a phase shift stage in the digital processing,

FIG. 8 shows the system of FIG. 2 including predistortion,

FIG. 9 shows the system of FIG. 3 including predistortion,

FIG. 10 shows the system of FIG. 5 including predistortion, and

FIG. 11 shows the system of FIG. 2 including envelope elimination and restoration.

### DESCRIPTION OF PREFERRED EMBODIMENTS

Referring to the drawings it will be appreciated that Cartesian loop systems according to the invention can be implemented in various forms to meet a wide range of standards required by radio communication equipment. These embodiments are given by way of example only, and parts of different embodiments can be combined in different ways. Many features of the systems such as modulation, demodulation, RF amplification, digital to analog and analog to digital conversion come in many forms that will be well known to skilled readers and need not be described in detail.

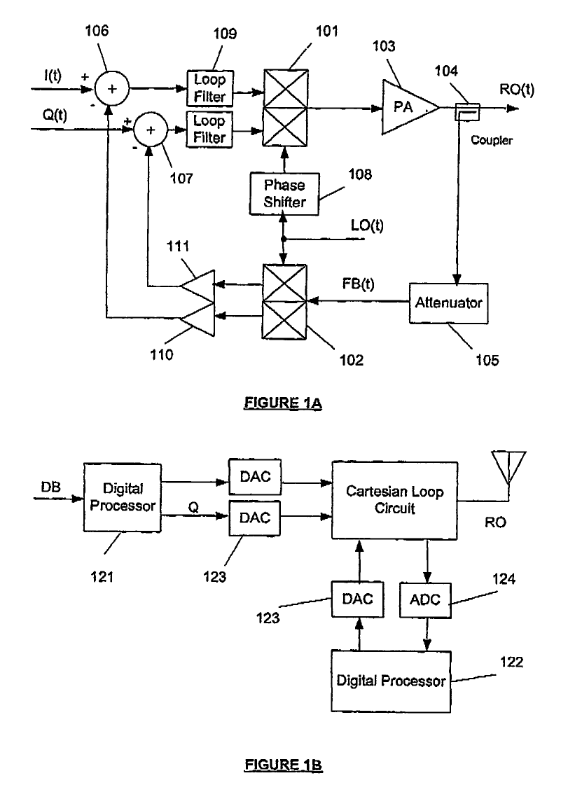

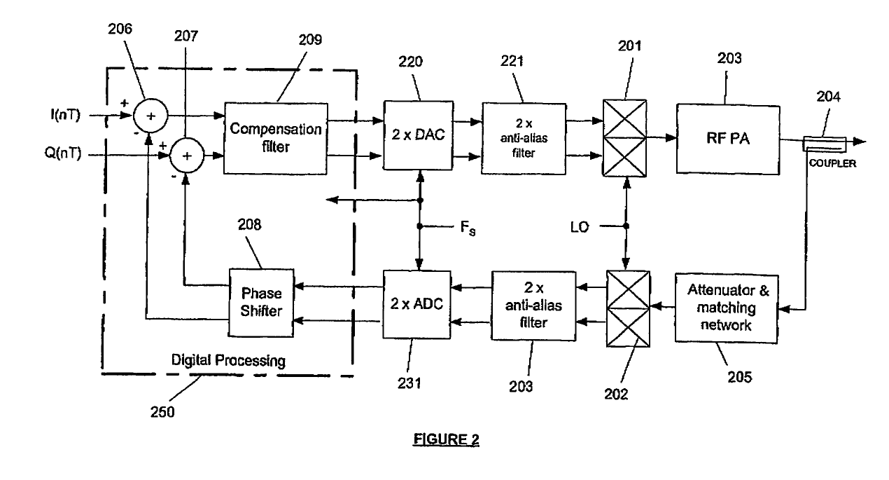

FIG. 1 A shows a conventional Cartesian loop system with analog circuitry, as briefly described above. A baseband input signal with analog quadrature components I and Q is used to modulate a carrier or local oscillator signal LO which is then amplified and output as a radio frequency signal RO. A feedback signal FB from the output is demodulated to form quadrature components which are subtracted from the input signal in real time to reduce overall distortion in the output

In FIG. 1A quadrature modulator 101 and demodulator 102 can operate in conventional ways. An RF amplifier 103 preferably operates at peak power for high efficiency, but thereby with increased non-linearity. Coupler 104 creates the feedback signal from the output of the amplifier. Attenuator 105 sets a suitable amplitude in the feedback signal. Adders 106, 107 combine quadrature components of the feedback signal in antiphase with respective components of the input signal to reduce the non-linearity. Phase shifter 108 is required to shift the phase of the carrier between modulator 101 and demodulator 102 in order to accommodate delays around the loop. Loop filters 109 determine the bandwidth and gain of the loop and reduce noise. Buffers 110 set signal levels for the adders.

FIG. 1B shows how the analog Cartesian loop circuit of FIG. 1A is typically used in a radio transmitter. Quadrature components I and Q of a digital baseband signal DB are formed in the digital processor 121. Calibration and configuration functions required to operate the loop are cased out by a digital processor 122, such as determination of DC offsets and phase shift estimation. The digital processors are connected to the analog Cartesian loop circuit by digital to analog and analog to digital converters, DACs 123 and ADC 124.

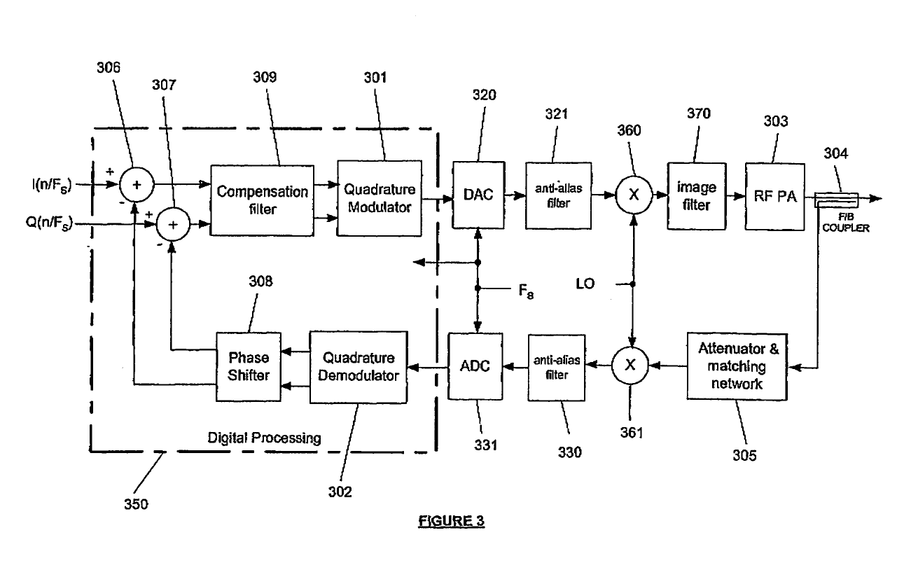

FIG. 2 shows a Cartesian loop system using a combination of digital and analog circuitry that can be implemented in a radio transmitter more effectively than a fully analog system. A digital processing stage 250 combines the quad components I, Q of the baseband input signal with respective components of the feedback signal, and preferably carries out several other requirements of the loop such as phase shifting and compensation for DC offsets. A range of digital processor devices are suitable such as DSP, FPGA or ASIC devices, for example. The baseband signals are coupled between digital and analog parts of the system through DAC and ADC devices that are now part of the loop. The DAC devices are linearised in the forward path and may be less highly specified than those in FIG. 1B.

In FIG. 2 the analog circuitry includes quadrature modulator 201 and demodulator 202, power amplifier 203, coupler 204 and an attenuator 205 which can be substantially similar to those of FIG. 1A. The baseband input components I, Q are upconverted by the modulator 201 to the frequency of the local oscillator signal LO and added for amplification and transmission. Conversely the feedback signal is donwnconverted and separated into quadrature components by the demodulator 202.

In FIG. 2 the digital processor 250 includes combiners 206, 207 that carry out real time subtraction of the feedback signal from the input signal, a phase shifter 208 that is now implemented precisely in baseband, either in the forward path or feedback path of the loop, and a filter 209 for stabilisation at a desired loop gain. Both the phase shifter and filter are readily implemented and calibrated by digital programming. A digital phase shift adds no noise to the loop and has no insertion loss, unlike the conventional analog phase shift approach. Calibration may take place once on startup or periodically as required. Digital baseband components I, Q output by the processor 250 in the forward path of the loop are sampled by DACs 220 at frequency Fₛ and passed in analog form to anti-alias filters 221. Quadrature components of the analog feedback signal from demodulator 202 are passed to anti-alias filters 230 and then to ADCs for sampling at Fₛ and input in digital form to the processor.

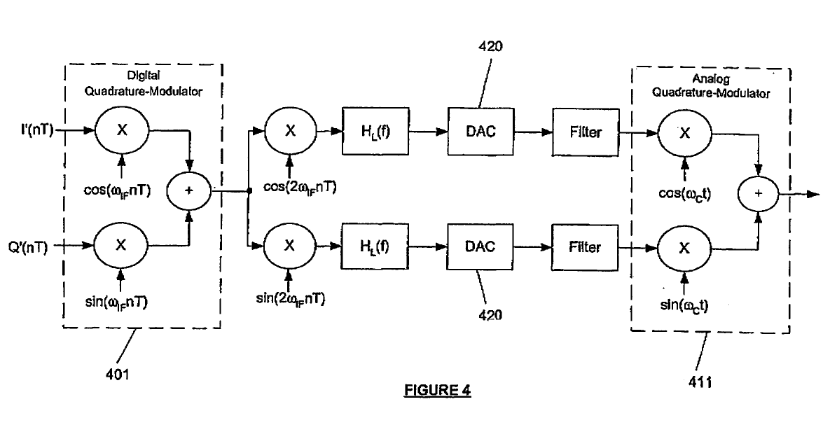

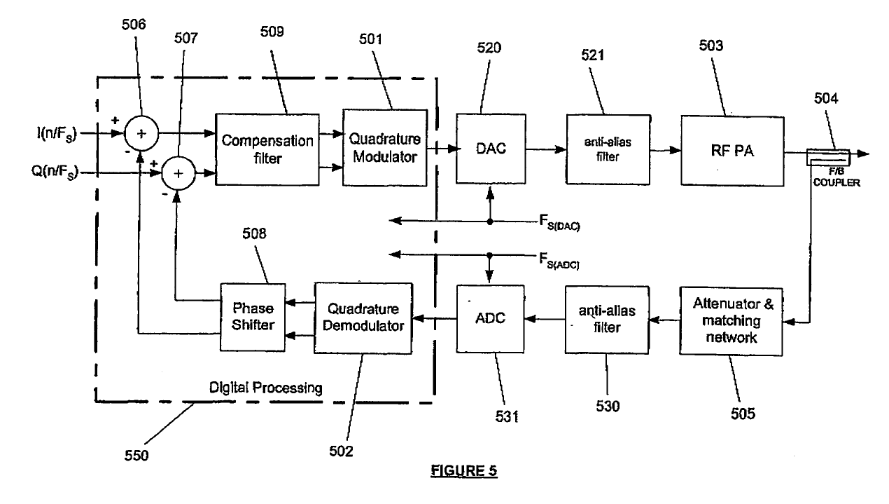

FIG. 3 shows an alternative Cartesian loop system using a combination of digital and analog circuitry that can be implemented in a radio transmitter for linearisation. The system has many similarities with the system of FIG. 2, except that the modulation and demodulation functions are now also carried out by the digital processor, at a relatively low intermediate frequency. This has an advantage that these functions are now carried out more accurately, in addition to the phase shift and stabilisation, but a disadvantage in that at least one final mixing stage is still required in the analog circuitry and an image that requires additional filtering is now generated. Alternatively however, the Weaver method as indicated in FIG. 4 may be used instead to generate the output signal at radio frequency without also generating an image.

In FIG. 3 the digital processor 350 includes combiners 306, 307 that carry out real time subtraction of the feedback signal from the input signal, a phase shifter 308 that is again implemented precisely in baseband, either in the forward path or feedback path of the loop, and a filter 309 for stabilization. Both the phase shifter and filter are readily implemented and calibrated by digital programming. Quadrature modulator 301 and demodulator 302 are also now included as digital processing functions.

In FIG. 3 the analog circuitry includes a frequency upconverter 360 and downconverter 361 that operate with a local oscillator signal LO, image filter 370, power amplifier 303, coupler 304 and an attenuator 305. The digital signal output by the processor 350 in the forward path of the loop is sampled by DAC 320 at frequency Fₛ that is more than twice the intermediate frequency of the modulator, and passed in analog form to anti-alias filter 321. The upconverter 360 then mixes the signal with a local oscillator signal LO followed by image filter 370 and amplifier 303 before transmission. The analog feedback signal from downconverter 361 is passed to anti-alias filter 330 and then to ADC 331 for sampling at Fₛ and input in digital form to the processor.

FIG. 4 indicates a Weaver subsystem that might be used in modifications of the systems in FIGS. 2 or 3, particularly the forward path of FIG. 2 and the reverse path of FIG. 3. The digital quadrature modulator 401 generates a modulated signal at frequency F_{IF} which is passed to a Weaver modulator in which an analog quadrature modulator 411 produces a modulated signal at F_{C-IF}. This allows use of the same local oscillator in either of the feedback paths in FIGS. 2 or 3. The digital and analog portions of the path are coupled by DACs 420. Further description of the Weaver method can be found in Communication Systems, S Haykin, 2^{nd} edition, J Wiley and Sons, 1983, pp 145,146, 171.

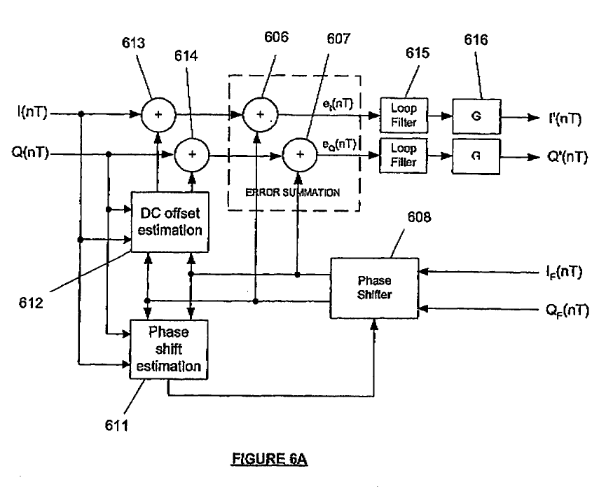

FIG. 5 shows a further alternative Cartesian loop system using a combination of digital and analog circuitry. The modulation and demodulation functions are carried out by the digital processor as in FIG. 3, but now at a relatively high frequency. These functions are carried out accurately in addition to the phase shift and DC compensation but without need of a further mixing stage because the modulation function takes place at the required frequency for transmission.

In FIG. 5 the digital processor 550 includes combiners 506, 507 that carry out real time subtraction of the feedback signal from the input signal, a phase shifter 508 in either the forward path or feedback path of the loop, and a filter 509 for stabilisation. Both the phase shifter and filter are readily implemented and calibrated by digital programming. Quadrature modulator 501 and demodulator 502 are also included as digital processing functions.

In FIG. 5 the analog circuitry includes power amplifier 503, coupler 504 and an attenuator 505. The digital signal output by the processor 550 is sampled by DAC 520 at rate Fₛ(DAC) to produce a series of images at multiples of the rate, one of which is the required transmission frequency. Anti-alias filter 521 removes the unwanted images. The analog feedback signal is passed from the coupler 504 and attenuator 505 to anti-alias filter 530 and then to ADC 531 for sampling at Fₛ(ADC) and input in digital form to the processor. Fₛ(DAC) may be an integer multiple of the Fₛ(ADC). Generally when Fₛ(DAC) is greater than Fₛ(ADC) an interpolator can be included in the feedback path before ADC 531 to change the effective sampling rate and reduce alias products resulting from the different sampling rates.

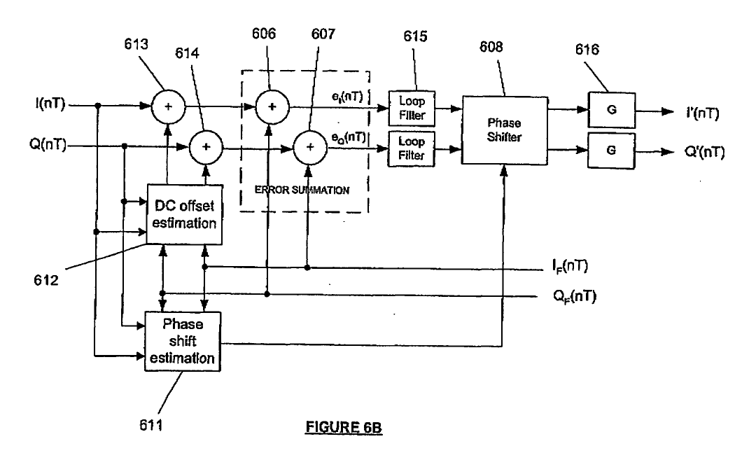

FIGS. 6A, 6B show alternative parts of the baseband processing that may take place in the digital processors 250,350,550. Quadrature components I, Q of the input baseband signal are combined with components I_{F}, Q_{F} of the feedback baseband signal, to produce components I′, Q′ of the signal in the forward path. The feedback components are subtracted from the input components to create components e_{I}, e_{Q} of an error signal that cancels distortion at the output of the loop. Corrections are generally applied to counter both delays and DC offset by devices around the loop, either before or after combination of the input signal with the feedback signal. In FIG. 6A a phase shift is applied to the feedback signal and a DC correction is applied to the input signal before combination of the feedback and input signals. In FIG. 6B the phase shift is applied to the combined signal in the forward path.

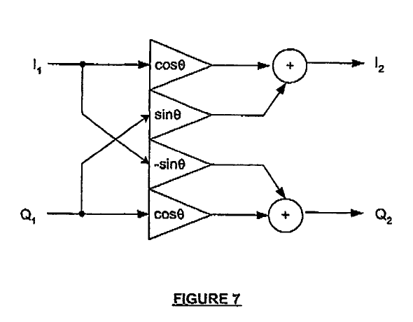

In FIGS. 6A, 6B the feedback components I_{F}, Q_{F} are added 180° out of phase to the input components I, Q by combiners 606, 607. Alternatively the action may be considered as an error summation in which a forward signal containing small input signal components and error components e_{I}, e_{Q} is generated. Phase shift block 608 acts on either the feedback components or the forward signal components, as will be described with more detail in relation to FIG. 7. The magnitude of the phase shift is determined by an estimation block 611, generally based on known properties of the Cartesian circuit, set during manufacture or on power up, perhaps modified by periodic updates when in operation. DC offsets are determined in estimation block 612 and subtracted from the input components I, Q by combiners 613, 614. Loop filter blocks 615 are generally necessary for stabilisation while gain blocks 616 are generally optional.

FIG. 7 indicates operation of the digital phase shifter 608 in FIGS. 6A, 6B. The phase shift can be considered as rotation of the vector formed by quadrature components of the particular signal. Delay in the loop effectively rotates the signal. If the vector of the feedback signal is not aligned with the vector of the input signal then signal components do not cancel and the loop becomes unstable. Correct alignment leaves the error signal and a small signal component. Phase shift of a signal I₁, Q₁ to I₂, Q₂ by angle θ can be carried out by a matrix operation as follows:

$$[ \begin{matrix}{I}_{2} \\ {Q}_{2}\end{matrix} ] = [ \begin{matrix}cos θ \\ - sin θ\end{matrix} \begin{matrix}sin θ \\ cos θ\end{matrix} ] [ \begin{matrix}{I}_{1} \\ {Q}_{1}\end{matrix} ]$$

The phase shift operation can also include compensation for gain imbalance and DC offset effects. If g and d are parameters required to equalise I, Q amplitude and DC imbalances, then the matrix operation can be expanded as follows:

$$[ \begin{matrix}{I}_{2} \\ {Q}_{2}\end{matrix} ] = [ \begin{matrix}g cos θ \\ - g sin θ\end{matrix} \begin{matrix}sin θ \\ cos θ\end{matrix} ] [ \begin{matrix}{I}_{1} \\ {Q}_{1}\end{matrix} ] + [ \begin{matrix}{d}_{1} \\ {d}_{2}\end{matrix} ]$$

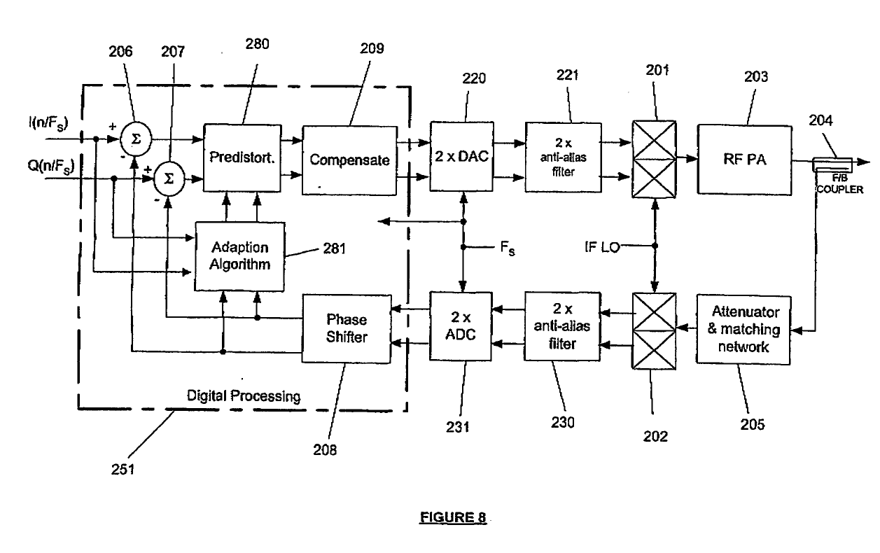

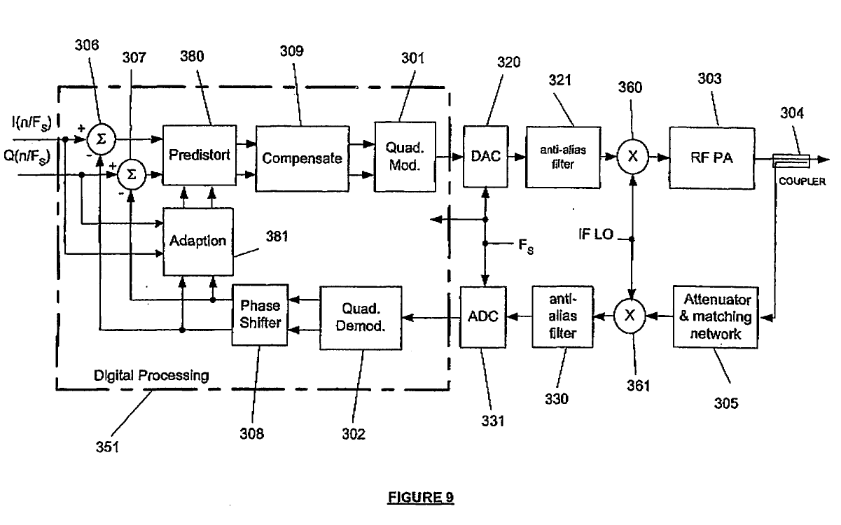

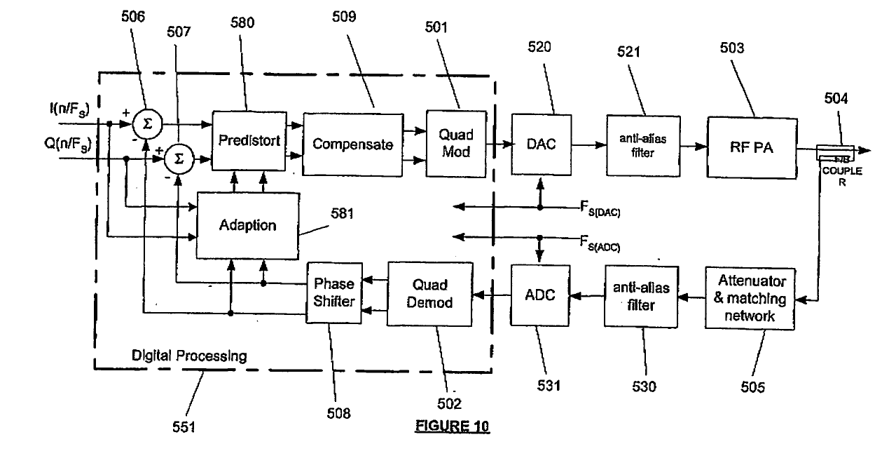

FIGS. 8, 9, 10 show how the systems of FIGS. 2, 3, 5 may be enhanced by combination of both Cartesian loop and predistortion techniques. Predistortion modifies the forward signal in the loop so that the combined characteristic of the predistorter and the power amplifier is linear. The characteristic of the amplifier changes with time and environment so an adaptive process is commonly used to update parameters required by the predistorter. The error signal created by the Cartesian loop is also predistorted, so that the predistorter linearises the amplifier and the Cartesian loop further linearises the system overall. It is alternatively possible to predistort the Cartesian feedback signal or the input signal.

In FIGS. 8, 9, 10 the Cartesian loop systems are readily modified by variation in the digital processing without need of additional analog components. Most of the digital and analog elements can remain the same. Predistortion blocks 280, 380, 580 respectively are added in the forward path of digital processors 251, 351, 551. Adaption blocks 281, 381, 581 respectively are also added to update parameters required by the predistortion blocks. Existing phase shift blocks 208, 308, 508 can remove the need for phase effects to be calculated in the predistortion or adaption blocks.

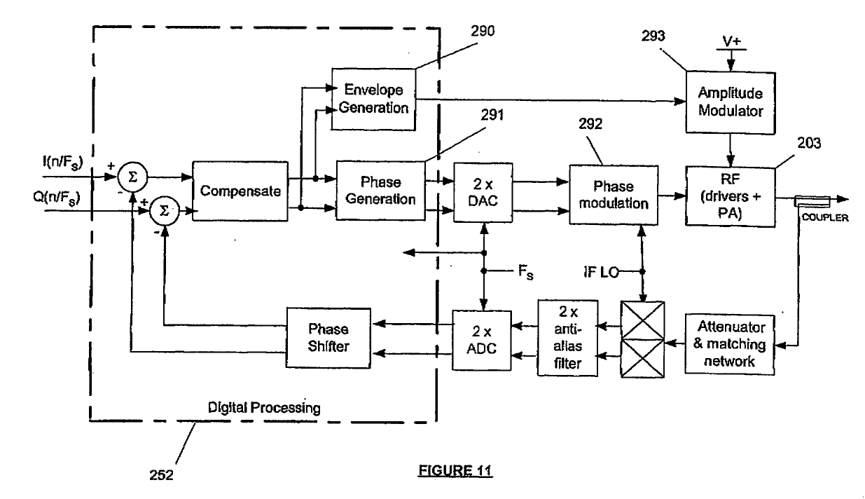

FIG. 11 shows how the system of FIG. 2 may be enhanced by combination of Cartesian loop and Envelope Elimination and Restoration techniques. EER divides the forward path to create an envelope signal and a phase signal, being polar rather than Cartesian components of the baseband signal. The envelope signal modulates the power supply of the amplifier while the phase signal has a constant amplitude and is amplified efficiently in a linear fashion. An envelope feedback path is usually added. EER is relatively simple and popular but does not achieve high linearisation. Delay lines are also required to compensate differences between the envelope and phase signal paths. Cartesian feedback can assist or replace envelope feedback, and reduce phase distortion effects due to high envelope modulation indexes and mismatched delays.

In FIG. 11 the Cartesian loop system has been modified with both digital and analog elements. Digital envelope and phase generation blocks 290, 291 produce the envelope and phase signals in the forward path of processor 252. An analog phase modulator 292 implemented as a quadrature modulator or a phase lock loop, for example, upconverts the phase signal to radio frequency before amplification. An amplitude modulator 293 such as a switching mode amplifier varies the voltage applied to the amplifier 203 according to the envelope signal. Alternatively the gate or base of the amplifier may be dynamically biased. The envelope and phase generation blocks are now inside the Cartesian loop and their specifications can be relaxed along with other elements normally outside the loop in analog Cartesian systems.

1. A Cartesian loop system for radio transmission equipment comprising:
digital processing circuitry that combines a baseband input signal with a Cartesian feedback signal to generate a forward signal, coupled to,
analog circuitry that converts the forward signal into a transmission output signal and generates the Cartesian feedback signal.

2. A system according to claim 1 further comprising:
DAC circuity that couples the forward signal from the digital processing circuitry to the analog circuitry, and
ADC circuitry that couples the Cartesian feedback signal from the analog circuitry to the digital processing circuitry.

3. A system according to claim 1 wherein the digital processing circuitry applies a phase shift process to the Cartesian feedback signal before combination with the baseband input signal.

4. A system according to claim 1 wherein the digital processing circuitry applies a predistortion process to the combined basedband input signal and Cartesian feedback signal when generating the forward signal.

5. A system according to claim 1 wherein the digital processing circuitry generates envelope and phase signals from the combined baseband input signal and Cartesian feedback signal, and the analog circuitry phase modulates the phase signal before amplification to create the radio frequency output signal, and modulates the amplification according to the envelope signal.

6. A system according to claim 1 wherein the digital processing circuitry applies a modulation process to the combined baseband input signal and Cartesian feedback signal when generating the forward signal, and applies a demodulation process to the Cartesian feedback signal before combination with the baseband input signal.

7. A system according to claim 1 wherein the foward signal is a pair of quadrature signals and the analog circuitry includes a quadrature modulator.

8. A system according to claim 1 wherein the analog circuitry includes an amplifier that generates the transmission output signal and a coupler that generates the Cartesian feedback signal from the transmission output signal.

9. A system according to claim 1 wherein the transmission output signal is generated by a weaver process implemented partly in the digital processing circuitry and partly in the analog circuitry.

10. A Cartesian loop circuit for transmitting baseband signals comprising:
a forward path for converting an input digital baseband signal to an analog RF output signal,
means for sampling the analog RF output signal to generate a feedback analog signal,
a feedback path for converting the analog feedback signal to a digital baseband feedback signal, and
digital processing circuitry that combines the input digital baseband signal with the digital feedback signal to create a combined signal for the forward path.

11. A circuit according to claim 10 wherein the digital processing circuitry applies a phase shift to either the feedback digital signal or to the combined sign.

12. A method of linearising a radio transmitter comprising:
(a) receiving a baseband input signal for transmission,
(b) digitally combining the input signal with a Cartesian feedback signal to generate a modified signal,
(c) upconverting and amplifying the modified signal to generate a radio frequency output signal, and
(d) generating the Cartesian feedback signal from the radio frequency output signal.

13. A method according to claim 12 further comprising:
(b1) digitally phase shifting the Cartesian feedback signal before combination with the baseband input signal.

14. A method according to claim 12 further comprising:
(b2) digitally predistorting the combined baseband input signal and Cartesian feedback signal to create the modified signal.

15. A method according to claim 12 further comprising:
(b3) digitally generating envelope and phase signals from the combined baseband input signal and Cartesian feedback signal,
(c1) phase modulating the phase signal before amplification to create the radio frequency output signal, and
(c2) modulating the amplification according to the envelope signal.

16. A method according to claim 12 further comprising:
(c1) digitally modulating a radio carrier signal with the modified signal before amplification to generate the radio frequency output signal.

17. A method according to claim 12 further comprising:
(d1) sampling the radio frequency output signal to generate a sample signal, and
(d2) quadrature demodulating the sample signal to generate the Cartesian feedback signal.
